(19) United States
(12) Patent Application Publication
(10) Pub. No.: US 2015/0024369 A1
(43) Pub. Date: Jan. 22, 2015

(54) PORTABLE MESSAGE BOARD

(71) Applicant: Damon Gabriel Brown, Atlanta, GA (US)

(72) Inventor: Damon Gabriel Brown, Atlanta, GA (US)

(21) Appl. No.: 14/325,319

(22) Filed: Jul. 7, 2014

Related U.S. Application Data
(60) Provisional application No. 61/820,577, filed on May 7, 2013.

(51) Int. Cl. B43L 1/02; G09F 21/02

(52) U.S. Cl. CPC B43L 1/02; G09F 21/02
USPC 434/416; 434/408; 434/417

(57) ABSTRACT

A handheld message board is provided. The message board includes a front portion and a back portion. The front portion may be made of an erasable writing surface, such as a chalk board or a dry-eraser board. The present invention may further include a handle attached to the back portion so that a user may easily grasp the handheld message board and write on the front portion. The handle includes a strap having a first end and a second end. The first end and the second end are attached to the back portion forming a loop in between to secure a user's hand.

### CROSS-REFERENCE TO RELATED APPLICATION

This application claims the benefit of priority of U.S. provisional application number 61/820,577, filed May 7, 2013, the contents of which are herein incorporated by reference.

### BACKGROUND OF THE INVENTION

The present invention relates to a message board and, more particularly, to a portable dry-erase or chalk board.

A dry-erase board is a name for any glossy, usually white surface for nonpermanent markings. Whiteboards are analogous to chalkboards, allowing rapid marking and erasing of markings on theft surface. The popularity of whiteboards increased rapidly in the mid-1990s and they have become a fixture in many offices, meeting rooms, school classrooms, and other work environments.

Current, dry-erase boards are affixed to a stationary object which does not facilitate an easy way to visually communicate to large audiences at varying points of view. The fixed nature of the dry-erase board forces the user to turn away from the audience when writing their message, and restricts the audience's viewpoint of the message.

Holding a portable dry-erase board for visually communicating to large audiences is difficult, awkward and typically requires two hands. Writing, drawing, erasing, and depicting messages on a dry-erase board in the field of use can be challenging given the sizes of the boards. The dry-erase markers and erasers can easily be lost. Further, the interpretation of the message can be misconstrued without the proper punctuation.

As can be seen, there is a need for an improved portable message board.

### SUMMARY OF THE INVENTION

In one aspect of the present invention, a message board comprises: a front portion comprising an erasable writing surface; a back portion; a handle comprising a strap having a first end and a second end, wherein the first end and the second end are attached to the back portion forming a loop in between.

These and other features, aspects and advantages of the present invention will become better understood with reference to the following drawings, description and claims.

### BRIEF DESCRIPTION OF THE DRAWINGS

FIG. 1 is a perspective view of the present invention, shown in use;

FIG. 2 is a front perspective view of the present invention;

FIG. 3 is a rear perspective view of the present invention;

FIG. 4 is an exploded view of the present invention;

FIG. 5 is a detail exploded view of the present invention;

FIG. 6 is a section view of the present invention, taken along line 6-6 in FIG. 2;

FIG. 7 is a detail section view of the present invention, illustrating the insertion of the marker cap into the holder;

FIG. 7A is a detail section view of the present invention, illustrating the removal of marker with the cap held in place by the holder;

FIG. 8 is a front perspective view of an alternate embodiment of the present invention, with the speech indicators in a deployed position;

FIG. 9 is a rear perspective view of an alternate embodiment of the present invention; and

FIG. 10 is a section view of the present invention, taken along line 10-10 in FIG. 8.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes dry-erase board utilizing a hand-strap, marker holders and speech bubbles. The invention allows a user to securely mount the portable message board comfortably to their hand allowing them to easily control and manipulate the present invention while engaged in writing, drawing, erasing messages, or other activities with the free hand.

The present invention includes a dry-erase board which utilizes a hand-strap to allow the user to comfortably have one-handed control of the device. The mounted nature of the present invention allows the user to visually communicate their message to audiences with varying viewpoints. The present invention may also utilize built-in marker (dry-erase) holders that retain the marker's cap when the marker is removed for use, thus eliminating the need to have both hands free to remove and replace the marker's cap.

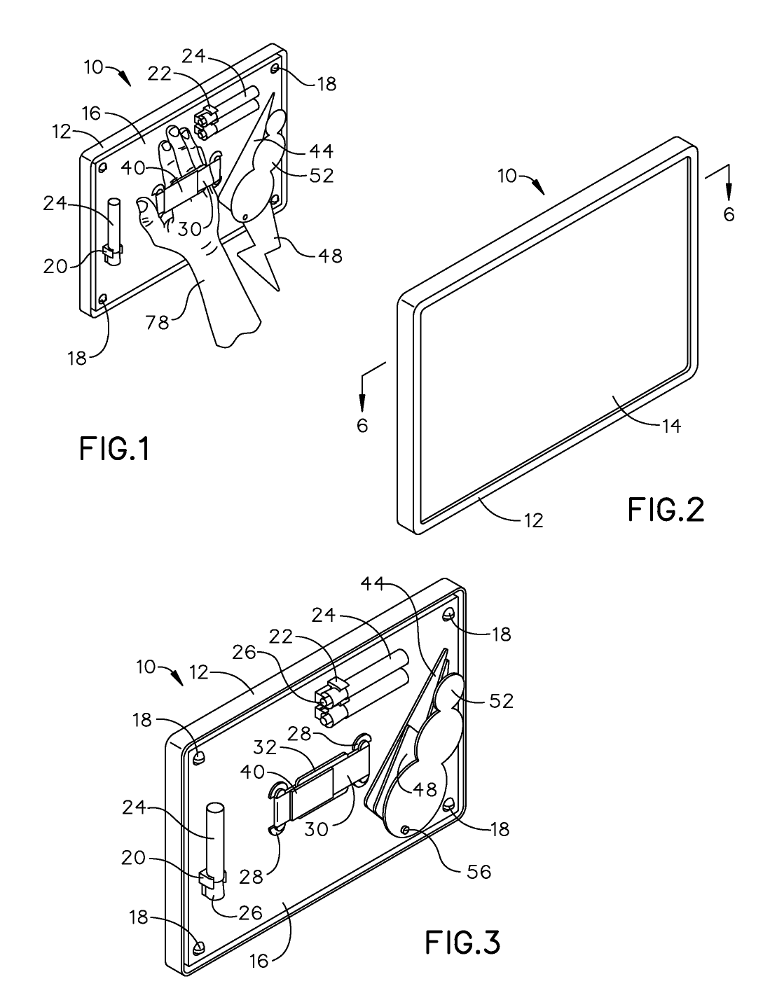

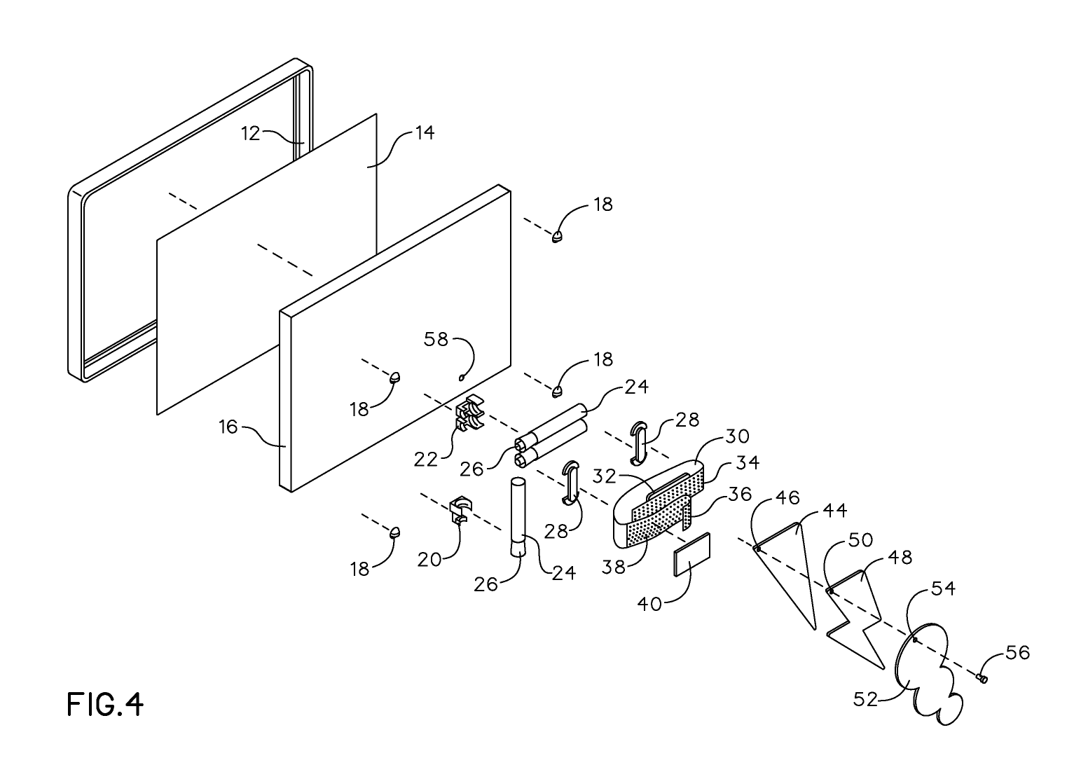

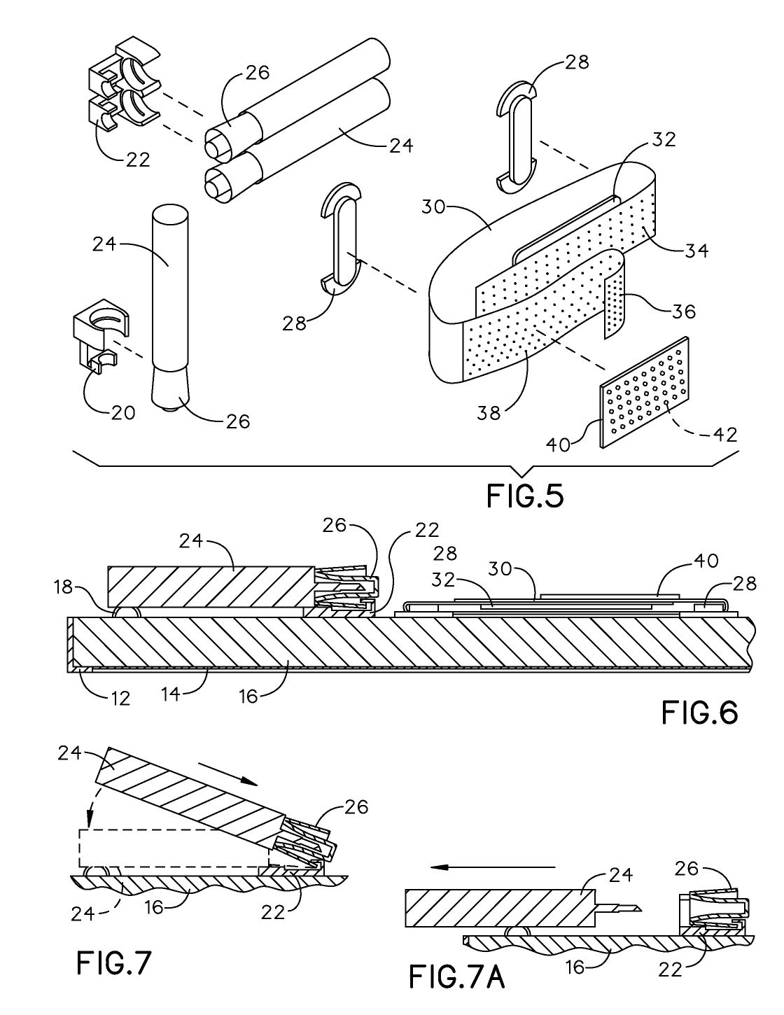

Referring to FIGS. 1 through 10, the present invention includes a handheld message board 10. The message board 10 includes a front portion 14 and a back portion 16. The front portion 14 may be made of an erasable writing surface, such as a chalk board or a dry-eraser board. The present invention may further include a handle attached to the back portion 16 so that a user may easily grasp the handheld message board 10 and write on the front portion. The handle includes a strap 30 having a first end and a second end. The first end and the second end are attached to the back portion 16 forming a loop in between to secure a user's hand 78.

In certain embodiments, the handheld message board 10 may be made of a frame 12 that secures the front portion 14 and the back portion 16 within. In certain embodiments, the present invention may include a front board that includes the front portion 14, and a back board that include the back portion 16. The front board and the back board may be secured within the frame 12. In certain embodiments, the back board may include anchors 18 attached. Shoulder straps, carabineers and the like may attach to the anchors 18 adding additional portability to the present invention. Further, an additional mounting plate may be affixed to the back board for other optional accessories, such as telescoping poles, furniture mounts and the like. The addition of slots on the side edges of the frame 12 may be used for pre-printed messages that may be added or removed from the message board 10.

The strap 30 of the present invention may be secured to the back portion 16 by any means. In certain embodiments, the present invention may include a pair of strap anchors 28. The strap anchors 28 may attach to the back portion 16 and include a channel for the strap 30 to wrap around. The strap 30 may include a strap pad 32 attached to an inner surface for additional securement and comfort. In certain embodiments, the strap 30 may be adjustable in length. For example, a first portion may include a hook fastener 34 and a second portion may include a loop fastener 36 which may be releasably attached. The hook and loop fasteners 34 may extend along a length of the strap 30 and may thereby be attached along different points, which may shorten or lengthen the length of the loop.

In certain embodiments, the present invention may further include at least one marker holder 20 or a double marker holder 22. As illustrated in FIG. 1, the present invention may include a plurality of marker holders 20, 22, such as three marker holders 20, 22. The marker holders 20 may be attached to the back portion 16, and may releasably secure a dry erase marker 24. The marker holder 20 may retain the cap 26 of the marker 24 so that a user 78 may easily grasp the marker 24 with one hand, and secure the handle of the message board 10 with another hand. In such embodiments, the marker holders 20 may include a lip formed to retain an upper edge of the cap 26, and a channel formed to retain a body portion of the cap 26.

In certain embodiments, the present invention may further include a dry eraser holder 38, 42, for releasably retaining a dry eraser 40 to the message board 16. Therefore, the user 78 of the message board 16 may easily access the dry eraser 40. In certain embodiments, the dry eraser holder 38, 42 may include a hook and loop fastener. For example, a loop fastener 42 may be attached to a surface of the dry eraser 40, and the hooked fastener 34 may be attached to the strap 30. Therefore, the dry eraser 40 may be easily attachable and removable from the strap 30 of the present invention.

The present invention may further include a plurality of speech indicators 44, 48, 52. The plurality of speech indicators 44, 48, 52 may be in a deployed position and a retracted position. The deployed position may include at least one of the plurality of speech indicators 44, 48, 52 protruding passed an edge of the message board 10 and the retracted position may include the plurality of speech indicators 44, 48, 52 within the borders of the edge of the message board 10. The plurality of expression indicators 44, 48, 52 may include a speech bubble flap 44, a shout bubble flap 48, and a thought bubble flap 52.

In certain embodiments, the plurality of speech indicators 44, 48, 52 may be pivotally attached to the back portion 16 of the message board 10 and may thereby pivot from the retracted position to the deployed position, and back to the retract position. In such embodiments, the speech bubble flap 44 may include a hole 46, the shout bubble flap 48 may include a hole 50, and the thought bubble flap 52 may include a hole 54. A pivot pin 56 may run through the holes 46, 50, 54 and secure within a pivot pin hole 58 of the back portion 16, thereby pivotally connecting the speech indicators 44, 48, 52 to the message board 10.

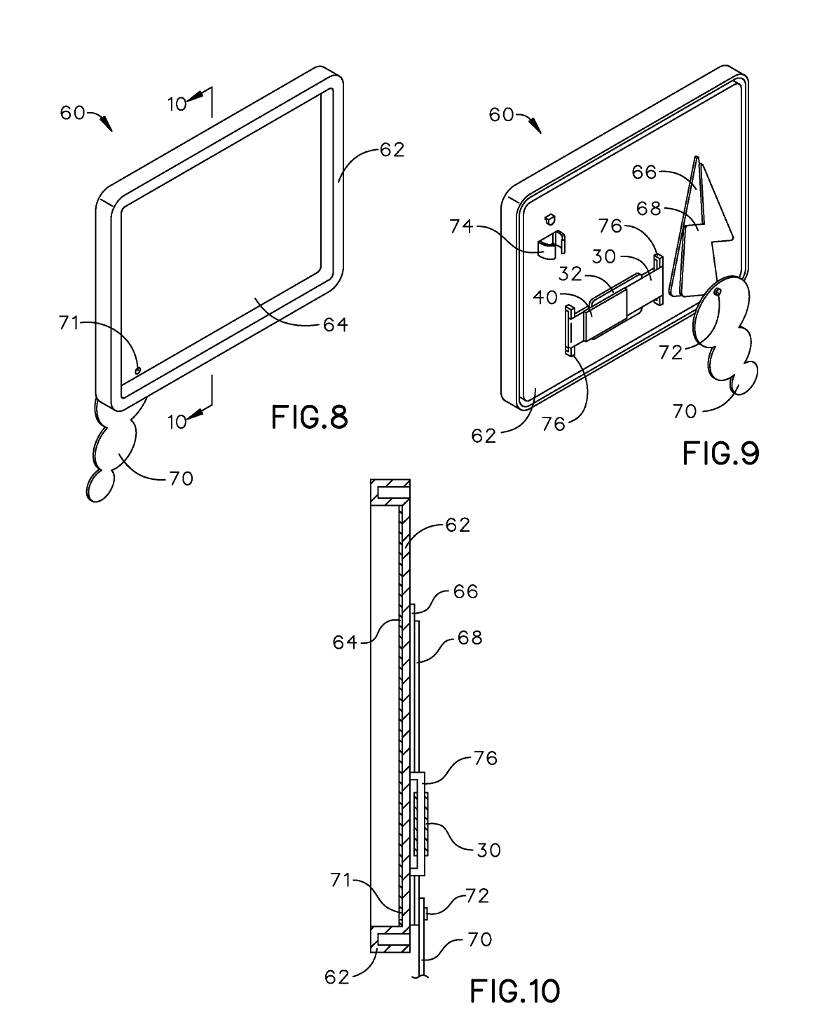

The present invention may include multiple embodiments, including different sizes, shapes and configurations. For example, as illustrated in FIGS. 8 through 10, the present invention may include a smaller handheld message board 60. The smaller message board 60 may include a smaller frame 62, a smaller writing surface 64, and a smaller plurality of flaps 66, 68, 70. Further, the smaller message board 60 may include a smaller pivot pin hole 71 as well as a smaller pivot pin 72. The message bored 60 may further include a single marker holder 74 and integrated strap anchors 76 to secure the strap 30.

A method of using the present invention may include the following. The user's hand is inserted into the loop formed by the hand-strap, which is attached to the anchors mounted on the back message board. The hand-strap is then adjusted by loosening or tightening the Velcro® straps to securely mount the user's primary hand to the back. The marker, cap and body, is attached into the holder mounted on the back. This allows the user to retrieve the writing utensil easily, by pulling the marker body with an upward motion using their free hand. The user is now able to create a message by using the marker on the writing surface. The marker cap may stay secured to the holder, allowing the user to return the marker to the holder for storage. The marker, cap and body, can be removed from the holder by applying reverse torque pulling the marker away from the back of signboard. The user can alter their message by detaching the eraser away from the hand-strap, and using the eraser to wipe the message on the writing surface until it has been cleaned. The user can add a visual connotation to their message by folding one of three different speech bubbles down and away from the bottom of the back of the present invention. The fold-out speech bubbles are depicted representations of action verbs that give the audience a sense that the user is talking, thinking, or shouting when viewing the signboard's writing surface. The present invention can be transported using optional accessories that attach to the transportation anchors that are mounted to the back of the signboard.

It should be understood, of course, that the foregoing relates to exemplary embodiments of the invention and that modifications may be made without departing from the spirit and scope of the invention as set forth in the following claims.

What is claimed is:

1. A message board comprising:
a front portion comprising an erasable writing surface;
a back portion;
a handle comprising a strap having a first end and a second end, wherein the first end and the second end are attached to the back portion forming a loop in between formed to receive a hand.

2. The message board of claim 1, wherein the strap is adjustable in length.

3. The message board of claim 2, wherein the strap is adjustable in length via a hook and loop fastener.

4. The message board of claim 1, further comprising at least one marker holder attached to the back portion, wherein a dry erase marker is releasably attachable to the marker holder.

5. The message board of claim 4, wherein the at least one marker holder comprises a clasp formed to retain a cap of the marker.

6. The message board of claim 5, wherein the at least one marker holder comprises a lip formed to retain an upper edge of the cap, and a channel formed to retain a body portion of the cap.

7. The message board of claim 1, further comprising a dry eraser holder formed to releasably retain a dry eraser.

8. The message board of claim 7, wherein the dry eraser holder is a hook and loop fastener attached to the strap.

9. The message board of claim 1, further comprising a plurality of speech indicators comprising a deployed position and a retracted position, wherein the deployed position comprises at least one of the plurality of speech indicators protruding passed an edge of the message board, and the retracted position comprises the plurality of speech indicators within the borders of the edge of the message board.

10. The message board of claim 9, wherein the plurality of expression indicators comprises a speech bubble, a shout bubble, and a thought bubble.

11. The message board of claim 9, wherein the plurality of expression indicators is pivotally attached to the back portion.

12. The message board of claim 1, further comprising a frame, a front board comprising the front portion, a back board comprising the back portion, wherein the front board and the back board are secured within the frame.

13. The message board of claim 1, wherein the erasable writing surface is a dry eraser surface or a chalk board.
